(19) United States
(12) Patent Application Publication
(10) Pub. No.: US 2005/0226642 A1
(43) Pub. Date: Oct. 13, 2005

(54) Estimation of marking material usage

(76) Inventors: Santiago Rodriguez, Boise, ID (US); Patrick Dougherty, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/704,516

(22) Filed: Nov. 7, 2003

(51) Int. Cl. G03G 15/08; B41J 2/195

(52) U.S. Cl. 399/27; 347/7

(57) ABSTRACT

Systems, methods, computer-readable media, and other embodiments are described for a system that estimates usage of a marking material in a print cartridge. One example system can include a coverage logic configured to determine a coverage value which is an average amount of marking material that covers a printed page of print media based on previous usage data. The system can also include a marking material remaining logic configured to determine a marking material remaining value for the print cartridge based, at least in part, on the coverage value.

### BACKGROUND

Some image forming devices like laser printers and ink jet printers include various mechanisms for determining how much toner or ink remains in a print cartridge. Example mechanisms may include pixel count accumulators and/or pulse width modulators. Adding these types of mechanisms to an image forming device may increase the amount of hardware and/or cost of the device. Some types of image forming devices do not include these mechanisms due to cost.

### BRIEF DESCRIPTION OF THE DRAWINGS

It will be appreciated that illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

FIG. 1 is an example system diagram of one embodiment of a system for determining a remaining toner level in a print cartridge.

FIG. 2 is an example system diagram of a toner remaining logic embodied in a computing device.

FIG. 3 is one example of a methodology for estimating a remaining toner level in a print cartridge.

FIG. 4 is one example of a methodology that can be used to update a coverage percentage for a selected image forming device.

### DETAILED DESCRIPTION OF ILLUSTRATED EMBODIMENTS

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of electromagnetic radiation, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or card, a carrier wave/pulse, or any other medium from which a computer, a processor or other electronic device can read. Signals used to propagate instructions or other software over a network, such as the Internet, or other transmission medium are also considered a “computer-readable medium.”

“Data Store”, as used herein, refers to one or more physical and/or logical entities that can store data. The data store may be embodied as one or more databases, tables, text files, linked lists, arrays, trees, memory locations, or other desired entity configured to store information. The data store may also include one or more indices, hash functions, relational components, or other mechanisms that assist in accessing the data store if desired. The data store, in one embodiment, may be embodied in a computer-readable medium.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), a programmable/programmed logic device, memory device containing instructions, or the like. Logic may also be fully embodied as software.

“Signal”, as used herein, includes but is not limited to one or more electrical signals, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

“User”, as used herein, includes but is not limited to one or more persons, software, computers or other devices, or combinations of these.

In one embodiment, a system is provided that estimates an amount of toner remaining in a print cartridge based on current usage data and previous toner usage data. The previous toner usage data includes data collected from previously used print cartridges. In one example, the amount of toner remaining in a print cartridge is determined, at least in part from, a coverage percentage that represents an average percentage of a page of print media that is covered by toner when the page is printed. After initially setting a value for the coverage percentage, e.g. 5%, the coverage percentage can be adaptive and be modified after usage data is collected from one or more print cartridges. Since different imaging devices can be used differently by different users, adapting the coverage percentage based on how an imaging device is used can provide a more accurate estimation of the amount of toner remaining in a currently installed print cartridge. It will be appreciated that the system can be configured to use different units of measure rather than a coverage percentage. For example, the coverage value may be in terms of an average volume of toner used to cover a single sheet of print media. Other modifications will also be readily apparent from reading and understanding the descriptions provided herein such as using toner weight as a unit of measure.

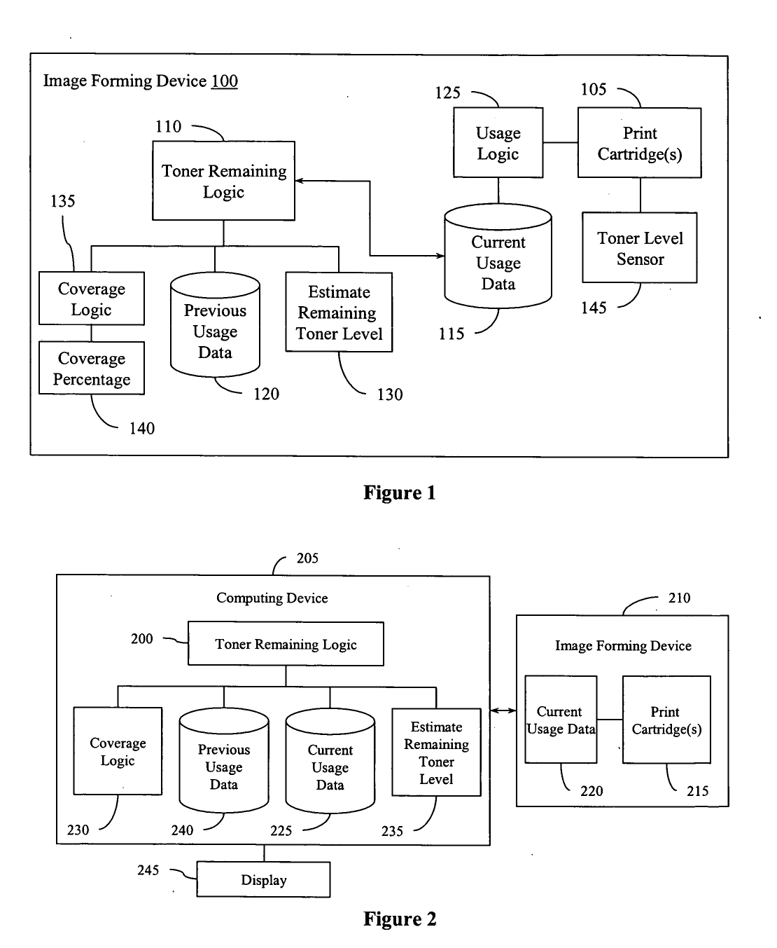

Illustrated in FIG. 1 is one embodiment of an image forming device 100 configured to determine an amount of toner remaining in a print cartridge 105. The image forming device 100 can be a printer, copier, an all-in-one product, a multifunctional peripheral device, or other device that can form an image onto print media. The image forming device 100 can include various types of imaging mechanisms based on, for example, technologies such as ink jet, piezoelectric, thermal printing, laser printing, digital imaging, impact printing, or other available technologies.

The image forming device 100 can be configured to use one or more print cartridges 105. It will be appreciated that the term “print cartridge” is used generically to represent any type of a removable/replaceable cartridge and/or refillable reservoir that may store and/or supply a marking material to an imaging mechanism. The marking material may include ink, toner, or other type of print material and, the marking material may be in a variety of forms such as liquid, semi-liquid, dry, powder, solid, semi-solid, or other forms. Although the term “toner” is used in some examples and claims herein, it will be appreciated that the term “toner” is intended to represent and include any desired marking material, and is not limited to toner.

Various configurations of the print cartridge 105 may also be provided but are not limited to the following configurations. For example, the print cartridge 105 may include one or more reservoirs where different color toner can be stored in each reservoir. In another example, the print cartridge 105 is also intended to cover multiple separate cartridges each storing a different color toner. In another embodiment, the print cartridge 105 may be configured to perform actual printing if, for example, the print cartridge 105 is combined with one or more components of a laser imaging mechanism, an ink jet print head, or other type of imaging mechanism.

With further reference to FIG. 1, a toner remaining logic 110 can be provided that is configured to determine an amount of toner remaining in the print cartridge 105. For example, the toner remaining logic 110 can estimate a toner remaining level in terms of a percentage value that can indicate to a user the remaining life of the print cartridge 105. For example, a toner remaining level may be 90% remaining, 65% remaining, 33% remaining, and so on. In one embodiment, the toner remaining logic 110 estimates the toner remaining level based, at least in part, on current usage data 115 and previous usage data 120. For example, the current usage data 115 can include data relating to a currently installed print cartridge (e.g. print cartridge 105) such as a total number of pages printed, a total page capacity that can be printed, sizes of printed pages, a number of print jobs printed, and other usage information. The current usage data 115 and the previous usage data 120 can be stored on any desired computer-readable-medium like a non-volatile memory, and can be maintained as any desired data store. As stated previously, the term “toner” is intended to represent any type of marking material. Thus, the toner remaining logic 110 can also be represented as a “marking material remaining logic” 110. The same intent applies to other components and features that use the term “toner.”

The image forming device 100 can include a usage logic 125 configured to monitor the usage of the print cartridge 105 and to store the usage data associated therewith. The usage logic 125 can be, for example, a logic attached to the print cartridge 105 like a smart chip, a logic local to the image forming device 100 like firmware, or other type of logic. Once the print cartridge 105 is removed, uninstalled, or otherwise replaced with a new print cartridge, the current usage data 115 can then be stored into the previous usage data 120. The previous usage data 120 can be maintained for one or more previously used print cartridges to create a history of usage data for this image forming device 100. Based on the previous usage data 120 and the current usage data 115, the toner remaining logic 110 can estimate a remaining toner level 130 for the print cartridge 105.

The image forming device 100 can also include a coverage logic 135 configured to determine or otherwise estimate a coverage percentage 140 that represents a percentage of a page of print media that is covered by toner during printing. For example, a standard page of paper (8½ inches by 11 inches) having ordinary text printed on it, may only have 5% of its surface area covered by toner. Thus, its coverage percentage would be 5%. Depending on the usage of the image forming device 100 and the types of printing performed, the coverage percentage 140 may increase or decrease.

In one example, for a first set of print cartridges 105 installed in the image forming device 100, an initial coverage percentage can be set by the coverage logic 135 or by a user. For example, the coverage percentage 140 can be initially set at 5%. Of course, other initial coverage values can be used. Since this is the first print cartridge installed in the image forming device 100, there may be no previous usage data 120. As such, the toner remaining logic 110 can estimate the remaining toner level 130, which is initially set at 100% remaining, by decreasing the remaining toner level 130 proportional to a number of pages printed by the print cartridge 105. One example equation to determine the remaining toner level 130 can be as shown in Equation (1) and can be used for each of the CMYK planes, respectively.
Toner remaining in %=[1−(Page Count/CRG capacity in pages)]*100 (1)
where “page count” is the number of pages printed by the cartridge. The page count can be scaled by a Letter Equivalent value (also shown as LTR equivalent) which is a weighting factor based on the size of each printed page. For example, a standard 8½×11 page (letter equivalent) can be assigned a value of 1, a legal sized page can have a weighting factor of 1.4 or other value greater than 1. Smaller sized print media can receive a smaller weighting factor and so on. “CRG capacity” represents an estimated total capacity of pages that can be printed by the print cartridge (printing standard letter size). The total capacity is typically provided by the manufacturer of the print cartridge based on the amount of toner within a full print cartridge. For example, based on the total volume of toner in a cartridge and an assumed coverage value, it may be estimated to print 5000 letter equivalent pages.

A modified version of Equation (1) can be used by the toner remaining logic 110 to estimate toner remaining which includes an adaptable value for toner coverage percentage shown as X %. The modified version shown in Equation (2) can be used for subsequently used print cartridges to determine the toner remaining level in terms of a percentage. It is noted that the equations can be modified to use other units of measure for toner remaining such as volume, weight, or other desired unit.
Toner Remaining in %=[1−(Page Count*X % Coverage)/(CRG capacity in pages*5%)]*100 (2)
where “5%” represents an assumed general purpose coverage percentage and “X %” represents an adaptable toner coverage percentage that can be based on previous usage data from one or more previously used cartridges. For example, when a second or subsequent cartridge is installed, the toner coverage based on the usage of the previous cartridge can be estimated using the actual “page count” and the last toner remaining level for the previous cartridge (e.g. the toner level remaining when the previous cartridge is removed). This usage data may be obtained from the usage logic 125, the usage data can be contained in a previous e-label value, may be mirrored in non-volatile memory (NVRAM), and used for subsequent cartridges. For example, after a print cartridge is removed/replaced, the toner coverage can be updated based on usage data from the removed print cartridge. The updated toner coverage can then be used as “X %” in equation (2) to better estimate the toner remaining level for a newly installed print cartridge.

The toner coverage can be estimated using the following example equations for a color cartridge, if present, after the cartridge has been used and/or removed:
K_{—}coverage=(1−K_{—}TR)*K Cartridge Life*5%/K Page Count in LTR Equivalent (3);
C_{—}coverage=(1−C_{—}TR)*C Cartridge Life*5%/C Page Count in LTR Equivalent (4);
M_{—}coverage=(1−M_{—}TR)*M Cartridge Life*5%/M Page Count in LTR Equivalent (5);
Y_{—}coverage=(1−Y_{—}TR)*Y Cartridge Life*5%/Y Page Count in LTR Equivalent (6);
and where
K_TR=Black cartridge Toner Remaining from TLS
C_TR=Cyan cartridge Toner Remaining from TLS
M_TR=Magenta cartridge Toner Remaining from TLS
Y_TR=Yellow cartridge Toner Remaining from TLS

“K_coverage” represents the toner coverage value for the black (K) print cartridge and the other coverage values correspond to their indicated color. “K Cartridge Life” represents a total number of pages that the black cartridge should be able to print which is similar to the “CRG capacity” value above. “5%” is an initial predetermined toner coverage but that value can be increased or decreased based on any known or estimated usage or market conditions for the image forming device 100. “Page Count” is the number of pages that have been printed by the cartridge in Letter (LTR) Equivalent up to when the cartridge is removed.

If a print cartridge includes a toner level sensor (TLS), for example toner level sensor 145, “K_TR” represents the toner remaining (TR) for the black (K) cartridge as measured by the toner level sensor. For example, if the toner level sensor is configured to measure the toner level within the cartridge when the toner level falls between 25% to 0%, the sensor is activated and can return a percentage of toner remaining or can return a signal from which the toner remaining value can be determined. The toner remaining percentage can be continuously or intermittently updated and stored in the current usage data 115 so that when the cartridge is removed, the toner remaining can be obtained.

If a print cartridge does not include a toner level sensor, the toner remaining values (K_TR, C_TR, M_TR, Y_TR) can be estimated using the above equations (1) or (2). The new toner coverage estimated above in Equations (3-6) can be used to estimate toner remaining for a second or subsequent cartridge. For subsequent cartridges, various alternatives can be followed. For example, a moving average for toner coverage may be used or printer lifetime coverage can be estimated and used instead.

With further reference to FIG. 1, in another embodiment, the usage logic 125 can be embodied as a print driver or other print control software that operates on a remote computer and can be configured to provide the usage data to the image forming device 100. For example, the print driver may provide data such as the number of pages in each print job, a number of print jobs submitted to the image forming device 100, the size of pages printed, and other desired usage data. This data can then be stored in the current usage data 115 for the print cartridge 105. If multiple computers are connected to the image forming device 100, each computer would be configured to provide usage data to the image forming device 100 in order to maintain more accurate information in the current usage data 115 about the usage of the image forming device 100.

With further reference to FIG. 1, in another embodiment, the print cartridge 105 includes a toner level sensor 145 that can be configured to sense and measure an amount of remaining toner in the print cartridge 105 between a desired range. For example, the toner level sensor 145 can be configured to activate once the toner remaining level is between 25% and 0%. Once the toner level sensor 145 is activated, a more accurate determination of the amount of toner remaining can be made rather than estimating the toner level with the toner remaining logic 110. Additional or more powerful sensors can be incorporated into the print cartridge 105 to increase the measurement range. Additional sensors could increase the cost of the print cartridge 105. The toner remaining logic 110 can be configured to determine the remaining toner level 130 until the toner level sensor 145 activates. At that time, the remaining toner level can be provided by the toner level sensor 145.

Illustrated in FIG. 2 is another embodiment of a toner remaining logic 200 embodied within a computing device 205 that is capable of communicating with an image forming device 210. In this example configuration, the computing device 205 can determine the amount of toner remaining in a print cartridge 215 for the image forming device 210 that may not have hardware/software to perform such processing. As the print cartridge 215 is used for printing, current usage data 220 can be monitored and stored, for example, by a usage logic (not shown). The current usage data 220 can be transmitted to the computing device 205 continuously or at any desired interval. A copy of the current usage data 225 can also be maintained on the computing device 205. As previously described, the current usage data 225 may include values such as a number of pages printed, a size of each page printed, a total page capacity of the print cartridge 215, and other desired usage data.

A coverage logic 230 can be configured to determine a coverage percentage to be used in determining a remaining toner level 235 in the print cartridge 215. For example, the remaining toner level 235 can be determined based on the number of pages printed, the total page capacity of the print cartridge 215, and the coverage percentage. The coverage logic 230 can be configured based on Equations (3-6). An initial coverage percentage can be set based on expected usage of the image forming device 210. Typical coverage percentages are about 4% to 6% but can be any percentage based on how the image forming device 210 is used.

After the print cartridge 215 is removed and replaced by a new print cartridge, the current usage data 225 can be copied and stored into a previous usage data 240. Any number of previous usage data 240 can be maintained for a selected image forming device 210 to maintain a history of usage data. The coverage logic 230 can then update the coverage percentage for the image forming device 210 based on the previous usage data 240 from previously used print cartridges. One example includes using the equations above. The updated coverage percentage can then be used to determine the remaining toner level 235 for the newly installed print cartridge 215 as the image forming device 210 prints pages.

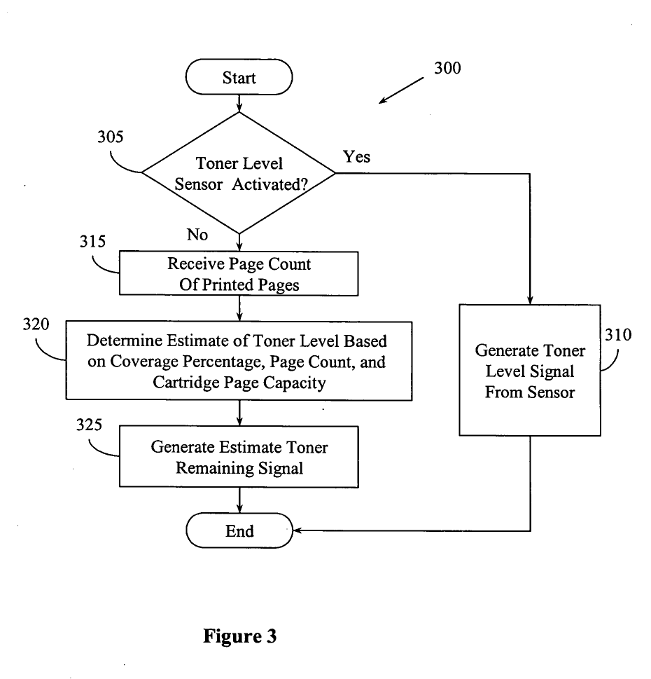

A display 245 can be used to display the remaining toner level 235 to a user via a graphical user interface (not shown). The graphical user interface can include logic configured to receive a remaining level of a marking material (e.g. the remaining toner level 235) within the print cartridge 215 where the remaining level is determined, at least in part, from current usage data 225 from the print cartridge 215 and from a coverage value being an average amount of marking material that covers a printed page of print media based on the previous usage data 240. The graphical user interface can be configured with logic that displays the remaining toner level 235 in variety of forms after it is determined by the systems and methods described herein. The variety of forms can be, for example, numerical, graphical, audible, combinations of these, or other forms like those described with reference to FIG. 3. The graphical user interface logic may be part of the computing device 205, may be part of the image forming device 210, and/or may be provided on any type of computer-readable medium.

If the print cartridge 215 includes a toner level sensor (not shown), the toner remaining level from the sensor at the time the print cartridge 215 is removed can be used to update the coverage percentage. For example, knowing the amount of toner remaining in the print cartridge 215, the number of pages printed by the print cartridge and the total page capacity of the print cartridge, the coverage logic 215 can determine how much toner was used to print the indicated number of pages printed and an average coverage percentage per page can be found. Of course, the coverage logic 230 and the toner remaining logic 200 can be configured to use other units of measure such as weight of toner, volume of toner, or other desired unit.

Illustrated in FIG. 3 is one embodiment of a methodology 300 for determining the remaining toner level in a print cartridge. The methodology 300 will be described with reference to a print cartridge that includes a toner level sensor that activates once the toner level falls to a specified range. The illustrated elements denote “processing blocks” and represent computer software instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, does not depict syntax of any particular programming language. Rather, the diagram illustrates functional information one skilled in the art could use to fabricate circuits, generate computer software, firmware, or use a combination of hardware and software to perform the illustrated processing. It will be appreciated that electronic and software applications may involve dynamic and flexible processes such that the illustrated blocks can be performed in other sequences different than the one shown and/or blocks may be combined or, separated into multiple components. They may also be implemented using various programming approaches such as machine language, procedural, object oriented and/or artificial intelligence techniques. The foregoing applies to all methodologies described herein.

With reference to FIG. 3, once the process begins, a determination is made whether the toner level sensor is activated (Block 305). If the sensor has activated, meaning that the toner level has fallen within a specified range such as between 25% to 0% remaining, the remaining toner level can be generated from data received from the sensor (Block 310), the data can be saved, and the process ends until another request is made to determine the remaining toner level. The process can also be continuously performed or be performed at one or more desired intervals.

If the toner level sensor is not activated at Block 305, meaning the toner level is outside of the specified range for the sensor, the remaining toner level is then determined from usage data. For example, a page count of printed pages is received (Block 315). The page count represents the total number of pages printed by the current print cartridge. The page count can also be weighted by a page size weighting factor as described previously as letter equivalent values. For example, standard size pages can be multiplied by a factor of “1”, legal size paper can be multiplied by a larger factor like “1.4”, and so on. In general, an assumption can be made that pages larger than a standard 8½×11 size page will receive more toner than the standard page, and smaller pages will receive less toner.

An estimate of the toner remaining level can then be determined using, for example, a coverage percentage, the page count of printed pages, and the page capacity of the print cartridge (Block 320). One equation that can be used is shown in equation (1) or (2) above. An estimate toner remaining signal can then be generated and displayed to a user to indicate how much toner is left (Block 325). The estimate signal can be in a variety of forms including a numeric value, a dial, a graphical value such as a graph or chart, a meter (e.g. a “full” to “empty” meter) an audible signal, combinations of these or other desired signal. The toner remaining signal can also be stored and/or transmitted to another device for subsequent processing.

It will be appreciated that if the sensor is not capable of providing a continuously or periodically updated toner level in block 310, the toner level can be estimated using the techniques described herein even when the toner level is within the activation range of the sensor. In this situation, the usage data (e.g. previous usage data) can be obtained from the currently installed print cartridge from data collected up to a point where the sensor activates. At that point, the coverage percentage can be estimated and updated. For example, if the sensor activates when the print cartridge has a 25% toner level remaining, the coverage percentage can be re-estimated using the number of pages printed and knowing that 75% of the toner volume has been used to print the pages. The example equations described previously can be modified where appropriate to accommodate this type of toner level sensor.

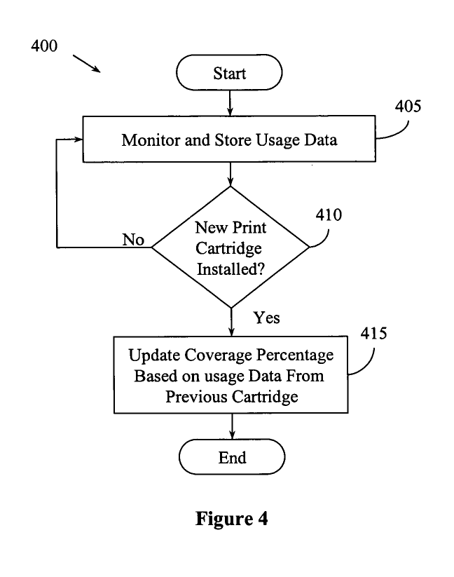

Illustrated in FIG. 4 is one embodiment of a methodology 400 that can be used to update the coverage percentage for a selected image forming device. As a print cartridge is used within the image forming device, usage data can be monitored and stored (Block 405). When it is sensed that the print cartridge has been removed and a new print cartridge is installed (Block 410), the removal can trigger a logic to update the coverage percentage. For example, the coverage percentage can be updated based on the usage data from the previously used cartridge (Block 415).

For example, knowing how much toner remained in the previous cartridge, the number of pages printed by the previous cartridge, and the total printing page capacity of the previous cartridge, it can be determined how much toner on average was used per page to cover each page. The updated coverage percentage can then be used on the current print cartridge to estimate the toner remaining level within the cartridge, for example, using equation (2). The process may also determine the average coverage percentage based on multiple previously used print cartridges and even an average value over the lifetime of the image forming device.

With the described systems and the methods, a determination can be made for the amount of toner remaining in a print cartridge for image forming devices having less sophisticated processing power such as devices that do not include pixel count accumulators. By estimating the toner usage based on adaptive coverage as described herein, a toner remaining level can be determined without negatively affecting printing performance of the image forming device since large processing power is not needed. The techniques described herein can also be modified and be used in products where a toner level sensor and/or pixel count accumulators are not present. For example, when a cartridge is replaced, a toner remaining of 0% can be assumed, or the last saved toner remaining value calculated using the coverage estimation described above can be used.

Suitable software for implementing the various components of the described embodiments using the teachings presented here include programming languages and tools such as Java, Pascal, C#, C++, C, CGI, Perl, SQL, APIs, SDKs, assembly, firmware, microcode, and/or other languages and tools. The components embodied as software include computer readable/executable instructions that cause one or more computers, processors and/or other electronic devices to behave in a prescribed manner. Any software/firmware, whether an entire system or a component of a system, may be embodied as an article of manufacture and maintained as part of a computer-readable medium as defined previously. Another form of the software and computer-readable medium may include signals that transmit program code of the software to a recipient over a network or other communication medium. Thus in one example, a computer-readable medium has a form of signals that represent the software/firmware as it is downloaded from a web server to a user. In another example, the computer-readable medium has a form of the software/firmware as it is maintained on the web server. Other forms may also be used. It will be appreciated that components described herein may be implemented as separate components or may be combined together.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both”. When the applicants intend to indicate “only A or B but not both” then the term “only A or B but not both” will be employed. Thus, use of the term “or” herein is the inclusive, and not the exclusive use.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A system that estimates a marking material remaining value for a print cartridge in an image forming device, the system comprising:
a coverage logic configured to determine a coverage value being an average amount of marking material that covers a printed page of print media based on previous usage data; and
a marking material remaining logic configured to determine a marking material remaining value for the print cartridge based, at least in part, on the coverage value.

2. The system of claim 1 where the coverage value and the marking material remaining value are determined as a unit of measure being one of, a percentage, a volume, and a weight.

3. The system of claim 1 wherein the previous usage data is obtained from one or more of, a print cartridge previously used by the image forming device and a currently installed print cartridge.

4. The system of claim 1 where the marking material remaining logic being further configured to determine the marking material remaining value for the print cartridge based, at least in part, on the coverage value and a number of pages printed by the print cartridge.

5. The system of claim 1 where the marking material remaining logic includes logic to decrease the marking material remaining value proportional to the number of pages printed by the print cartridge.

6. The system of claim 1 where the previous usage data includes at least a number of pages printed by the previously used print cartridge and a toner remaining level of the previously used print cartridge.

7. The system of claim 1 where the system is embodied in an image forming device.

8. The system of claim 1 where the system is embodied as one of, software in a computing device operable to communicate with the image forming device, and instructions capable of being transmitted over a communication network.

9. A method for determining a marking material level within a current print cartridge, the method comprising:
determining a number of pages printed by a previously used print cartridge;
determining a previous marking material remaining level of the previously used print cartridge;
determining a previous coverage percentage based, at least in part, on the number of pages printed by the previously used print cartridge and the previous marking material remaining level of the previously used print cartridge, where the previous coverage percentage represents a percentage of a page of print media that is covered by marking material;
counting a number of pages printed by the current print cartridge; and
estimating a marking material level within the current print cartridge based, at least in part, on the previous coverage percentage and the number of pages printed by the current print cartridge.

10. The method of claim 9 wherein the determining the previous marking material remaining level includes reading the previous marking material remaining level from a memory.

11. The method of claim 9 further including storing usage history data from one or more previously used print cartridges.

12. The method of claim 11 wherein the storing of the usage history data includes one or more of, storing the number of pages printed, and sizes of printed pages.

13. The method of claim 9 wherein the determining the previous marking material remaining level is determined at a time when the previously used print cartridge is removed.

14. The method of claim 9 wherein the estimating is further based on a total page capacity of the current print cartridge.

15. The method of claim 9 wherein the previous marking material remaining level and marking material level within the current print cartridge are calculated as percentages.

16. The method of claim 9 wherein the current print cartridge is installed and used subsequent to the previously used print cartridge.

17. A computer-readable medium including instructions for causing logic to determine a marking material remaining level of a print cartridge by a method comprising:
storing a first usage data of a first print cartridge;
storing a second usage data of a second print cartridge; and
determining a marking material remaining level of the second print cartridge based, at least in part, on the first usage data and the second usage data.

18. The computer-readable medium as set forth in claim 17 where the second print cartridge is installed subsequent to the first print cartridge and where the second usage data is collected subsequent to the first usage data.

19. The computer-readable medium as set forth in claim 17 wherein the first usage data includes a number of pages printed by the first print cartridge and a percentage of marking material remaining in the first print cartridge when the first print cartridge is uninstalled.

20. The computer-readable medium as set forth in claim 17 wherein the determining includes determining a coverage percentage that represents an average percentage of a page of print media that is covered by marking material during printing.

21. The computer-readable medium as set forth in claim 17 wherein the second usage data includes a number of pages printed by the second print cartridge.

22. The computer-readable medium as set forth in claim 17 further including means for determining a marking material coverage percentage from the first usage data where the marking material remaining level is based on the marking material coverage percentage.

23. The computer-readable medium as set forth in claim 17 being embodied as signals propagated over a communication network.

24. An image forming device comprising:
an imaging mechanism configured to operate with one or more replaceable print cartridges containing marking material;
a coverage logic configured to determine a coverage value for each of the one or more replaceable print cartridges where the coverage value being an average amount of marking material that covers a printed page of print media based on previous marking material usage data from a previously used print cartridge; and
a marking material remaining logic configured to determine a marking material remaining value for the one or more replaceable print cartridges based, at least in part, on the coverage value and a number of pages printed by the one or more replaceable print cartridges.

25. A computer system comprising:
a coverage logic configured to determine a coverage value for one or more replaceable print cartridges from an image forming device where the coverage value being an average amount of marking material that covers a printed page of print media based on previous marking material usage data from a print cartridge previously used by the image forming device; and
a marking material remaining logic configured to determine a marking material remaining value for the one or more replaceable print cartridges based, at least in part, on the coverage value and current usage data from the one or more replaceable print cartridges.

26. A method for determining a marking material level within a current print cartridge, the system comprising:
determining a previous coverage percentage based, at least in part, on previous usage data from a previously used print cartridge where the previous coverage percentage represents a percentage of a page of print media that is covered by a marking material; and
estimating a marking material level within the current print cartridge based, at least in part, on the previous coverage percentage.

27. The method of claim 26 where the previous usage data includes a number of pages printed by the previously used print cartridge; and
where the determining step includes using at least the number of pages printed by the previously used print cartridge to determine a previous marking material remaining level of the previously used print cartridge.

28. The method of claim 27 where the determining step is further based, at least in part, on the previous marking material remaining level of the previously used print cartridge.

29. The method of claim 26 further comprising:
counting a number of pages printed by the current print cartridge; and
where the estimating step is based, at least in part, on the previous coverage percentage and the number of pages printed by the current print cartridge.

30. A graphical user interface comprising:
logic configured to receive a remaining level of a marking material within a print cartridge, the remaining level being determined, at least in part, from current usage data from the print cartridge and from a coverage value being an average amount of marking material that covers a printed page of print media based on previous usage data; and
logic configured to display the remaining level of the marking material.
